(19) United States
(12) Patent Application Publication
(10) Pub. No.: US 2026/0220943 A1
(43) Pub. Date: Jul. 30, 2026

(54) METHOD AND SYSTEM FOR IDENTIFICATION OF AN OBJECT IN A METALLURGICAL FACILITY

(71) Applicant: REFRACTORY INTELLECTUAL PROPERTY GMBH & CO. KG, Wien (AT)

(72) Inventor: Romy-Sophie KATZ, Wien (AT)

(21) Appl. No.: 19/141,398

(22) PCT Filed: May 23, 2024
(86) PCT No.: PCT/EP2024/064234

§ 371 Date: Jun. 20, 2025

(30) Foreign Application Priority Data
May 26, 2023 (EP) EP23175673

(51) Int. Cl. G06V 20/52; G06N 20/00; G06V 10/74; G06V 10/764; G06V 20/60

(52) U.S. Cl. CPC G06V 20/52; G06N 20/00; G06V 10/74; G06V 10/764; G06V 20/60; G06V 2201/06

(57) ABSTRACT

Method for identification of an object (1), such as a specific metallurgical ladle (2b), out of members oₖ, k=1 . . . n (3) of a class of objects O={oₖ|k=1 . . . n} (2), such as movable vessels (2a), in a metallurgical facility (90), the method comprising the following steps: A first providing step (100) where members oₖ, k=1 . . . n (3) of a class of objects O={oₖ|k=1 . . . n} (2) are provided and where an artificial intelligence-based detection algorithm (11) is provided, the artificial intelligence-based detection algorithm (11) is configured to detect a presence of any of the members oₖ, k=1 . . . n (3) of the class of objects O={oₖ|k=1 . . . n} (2) in an optical image (21); A capturing step (200) where at least one first optical image (21) of a part of the metallurgical facility (90) is provided by at least one optical imaging device (20), such as a 2D camera (20a); A detection step (300) where the presence of any of the members oₖ, k=1 . . . n (3) of the class of objects O={oₖ|k=1 . . . n} (2) in the at least first optical image (21) is detected by the artificial intelligence-based detection algorithm (11), such that an area (22) with the presence of at least a part of any of the members oₖ, k=1 . . . n (3) of the class of objects O={oₖ|k=1 . . . n} (2) in the at least first optical image (21) is recognized; A second providing step (400) where an artificial intelligence-based identification algorithm (12) is provided, the artificial intelligence based identification algorithm (12) is configured to identify the member oᵢ∈O (3) out of the members oₖ, k=1 . . . n (3) of the class of objects O={oₖ|k=1 . . . n} (2) in the area (22) and further is configured to assign a member ID IDᵢ (4) of the identified member oᵢ∈O (3) of the class of objects O={oₖ|k=1 . . . n} (2) to the object (1); An identification step (500) where the member oᵢ∈O (3) of the class of objects O={oₖ|k=1 . . . n} (2) is identified in the area (22) by the artificial intelligence-based identification algorithm (12) by assigning the member ID IDᵢ (4) of the identified member oᵢ∈O (3) of the class of objects O={oₖ|k=1 . . . n} (2) to the object (1); a data providing step (700) where a data structure (30) is provided to a central data processing unit (50), the data structure (30) comprises the member ID IDᵢ (4) assigned to the object (1), preferably the data structure (30) further comprises a time stamp; a comparison step (900) where a target (81) provided from a production system (80), preferably the target (81) comprises an object ID target (82) and a position target (83), is compared with the data structure (30) provided in the data providing step (700), preferably the data structure comprises the member ID IDᵢ (4) assigned to the object (1) and the position (5) of the object (1); a warning step (1000) where a warning signal (85) is generated in case the data structure (30) differs from the target (81). Further a processing system (49) for identification of an object (1).

The invention relates to a method and system for identification of an object, such as a specific metallurgical ladle, out of members of a class of objects, such as movable vessels, in a metallurgical facility.

EP 3 656 485 A1 discloses a control system and method for monitoring location of a ladle in a metallurgical facility which uses an imaging unit along with a first set of sensors present on the transfer cars and second set of sensors present on the cranes to track the movement of ladles.

EP 3 575 866 A1 discloses a mobile surveillance unit for a metallurgical facility.

WO 2016/119925 A1 discloses monitoring a metallurgical vessel, which is equipped with a transponder.

KR20160076830 discloses a system and method for managing a ladle used in a steel production process, which grasps the location of the ladle in real time, and also monitors the state of the ladle at a certain point.

AISTech 2019—Proceedings of the Iron & Steel Technology Conference (DOI 10.1000.377.096) p. 923 ff discloses a fully automatic detection of moving vessels like ladles, slag pots, torpedo ladles, etc. based on identification of three-dimensional features using TOF (Time Of Flight) technology.

The report “European Commission Research Programme of the Research Fund for Coal and Steel Technical Group: TGS 9 Consistent ladle tracking for optimisation of steel plant logistics and product quality TrackOpt” https://www.cetic.be/IMG/pdf/deliverable 1.1 ladle tracking set-up selected and tested.pdf discloses automated ladle tracking systems using a SAW sensor and a ladle identification using cameras and a finger print plate welded to the ladle.

EP3883707 discloses a control system and method for monitoring the location of a ladle in a metallurgical facility, which uses an imaging unit and several sensors.

CN109598200B discloses an image intelligent identification system and method for a molten iron tank number. CN115439837A discloses a system and method for identifying and tracking ladle number of iron ladle. CHONG WU ET AL: “Research of Molten Iron Ladles location based on number recognition”, 2015 CHINESE AUTOMATION CONGRESS (CAC), IEEE 27 Nov. 2015 (2015 Nov. 27), pages 2106-2109, XP032850779, DOI: 10.1109/CAC.2015.7382852 discloses a number recognition for molten iron ladles.

A metallurgical facility (sometimes also called a metallurgical plant) is generally a facility to produce metallurgical products, such as, e.g., steel in a steel plant. In such a metallurgical facility, moveable (metallurgical) vessels are generally used to transport and/or treat (liquid) metal. In case of a steel plant, such moveable vessels can, e.g., be metallurgical ladles (such as hot metal or steel ladles), slag pots, tundishes, scrap buckets/boxes or alike. Such moveable vessels generally comprise an outer hull made of steel, which is used to give the moveable vessel structural stability. The hull may provide or may be connected to some means for transporting the moveable vessels (by means of, e.g., a crane), such as e.g., lugs, or trunnions or brackets or alike. In many processes in a metallurgical facility, it is essential, that the moveable vessels in operation are closely monitored, so that process deviations (e.g., due to a too low temperature of the liquid metal within a moveable vessel upon arrival at a certain treatment station) are reduced or fully prevented. Therefore, there exists a big need in the metallurgical industry to identify (and track) objects, such as movable vessels, in a metallurgical facility in a simple, effective, and reliable manner.

While many attempts have been made to identify (and track) objects, such as movable vessels, in a metallurgical facility, the harsh (operating) conditions of such a metallurgical facility need to be taken into consideration. Therefore, such attempts have either not been very simple or robust, as they involved special installations on the to-be-tracked objects (e.g., adding sensors, ID tags or alike on steel ladles), and/or required to be serviced and checked on a regular basis (e.g., is the sensor still working?, is the ID tag still in place?). In consequence, these attempts have not been highly reliable or simply have been too complicated to be worked in the harsh environment of a metallurgical facility.

Therefore, it is an objective of the invention to provide a method, an acquisition system and a processing system for identification of an object, such as a specific metallurgical ladle, out of members oₖ, k=1 . . . n of a class of objects O={oₖ|k=1 . . . n}, such as movable vessels, in a metallurgical facility which are simple, robust and reliable.

The objective is achieved by a method according to claim 1 and by an acquisition system according to claim 13 and a processing system according to claim 15.

The inventor has realized, that for an efficient and reliable identification of objects in a metallurgical facility, it is possible to use an optical image and use a two-step approach using two artificial intelligence-based algorithms comprising the following steps:
(i) detect the presence (only) of any member of a class of objects (e.g., steel ladles) by an artificial intelligence-based detection algorithm and if such a presence is detected in an area of the image, then
(ii) identify this specific member in the area and assign a (unique) member ID to the object by an artificial intelligence-based identification algorithm.

The core idea of the invention is based on the finding, that the combination of an artificial intelligence-based detection algorithm and an artificial intelligence-based identification algorithm can reliably detect and identify the presence and the identity of an object, such as a specific metallurgical ladle out of members of a class of objects, such as moveable vessels in a metallurgical facility. Furthermore, the separation of the detection of the presence and the subsequent identification of an object in an area leads to reduced required computational power, such that the method preferably can be run on small remote acquisition system(s). This two-step approach has proven to yield a very high recognition rate, while the time for training the two artificial intelligence-based algorithms is comparably low. Furthermore, it is preferable that the remote processing of images reduces the demand for data transmission between the remote acquisition system(s) and a central data processing unit, as no complete image files but only a reduced data structure, e.g., comprising a member ID and a position, is sent to the central data processing unit instead.

In this context, a processing unit (such as a data processing unit, or a central data processing unit or an acquisition data processing unit) is understood to mean one or more devices for carrying out the respective method steps described below, and which, for this purpose, comprise either discrete electronic components to process signals, or which are implemented partially or completely as a computer program in a computer.

A capturing step where at least one first optical image of a part of the metallurgical facility is provided by at least one optical imaging device, such as a 2D camera, is to be understood as a step which causes an imaging device to provide an optical image. Such capturing can be performed by sending a signal instruction to an imaging device to trigger capturing of an optical image, and further receiving the optical image at a computer, e.g., receiving such optical images at a processing unit (such as in the second and third embodiment). Capturing can also be performed by selecting a certain optical image from a (e.g., constant) stream of optical images provided by an imaging device, such as a video camera, and further by receiving the optical image at a computer, e.g., receiving such optical images at a data processing device (such as in the second and third embodiment).

An imaging device is to be understood as an electronic appliance for acquisition of optically detectable signals (points), generally comprising an optical system (such as a lens) and a sensor (e.g., CCD or CMOS sensor) and an electronic circuit. Preferably, the imaging device is a digital camera, such as a 2D camera. Preferably, the imaging device is positioned at a fixed (i.e., non-movable) location. In such a case, the imaging device might, e.g., be fixed to the ground or to any support structure of the metallurgical facility, which reduces the effort for training the artificial intelligence-based detection algorithm, as the viewport will remain constant relative to parts of the background.

In a first embodiment of the invention, the objective is achieved by providing a method for identification of an object, such as a specific metallurgical ladle, out of members oₖ, k=1 . . . n of a class of objects O={oₖ|k=1 . . . n}, such as movable vessels, in a metallurgical facility, the method comprising the following steps:
A first providing step where members oₖ, k=1 . . . n of a class of objects O={oₖ|k=1 . . . n} are provided and where an artificial intelligence-based detection algorithm is provided, the artificial intelligence-based detection algorithm is configured to detect a presence of any of the members oₖ, k=1 . . . n of the class of objects O={oₖ|k=1 . . . n} in an optical image;
A capturing step where at least a first optical image of a part of the metallurgical facility is provided by at least one optical imaging device, such as a 2D camera;
A detection step where the presence of any of the members oₖ, k=1 . . . n of the class of objects O={oₖ|k=1 . . . n} in the at least first optical image is detected by the artificial intelligence-based detection algorithm, such that an area with the presence of at least a part of any of the members oₖ, k=1 . . . n of the class of objects O={oₖ|k=1 . . . n} in the at least first optical image is recognized;
A second providing step where an artificial intelligence-based identification algorithm is provided, the artificial intelligence-based identification algorithm is configured to identify the member oᵢ∈O out of the members oₖ, k=1 . . . n of the class of objects O={oₖ|k=1 . . . n} in the area and further is configured to assign a member ID IDᵢ of the identified member oᵢ∈O of the class of objects O={oₖ|k=1 . . . n} to the object;
An identification step where the member oᵢ∈O of the class of objects O={oₖ|k=1 . . . n} is identified in the area by the artificial intelligence-based identification algorithm by assigning the member ID IDᵢ of the identified member oᵢ∈O of the class of objects O={oₖ|k=1 . . . n} to the object.

This allows an object to be identified in a metallurgical facility.

In the first providing step, the provided members oₖ, k=1 . . . n of a class of objects O={oₖ|k=1 . . . n} may comprise any specific movable vessel of such class of objects, such as, e.g., a specific metallurgical ladle, a specific slag pot, a specific tundish, a specific scrap bucket/box. A class of an object O={oₖ|k=1 . . . n} is preferably predefined and comprises several members oₖ, k=1 . . . n, which belong to the class, each member of preferably comprises a member ID IDᵢ.

A first class could be the class of metallurgical vessels, where the first class comprises several metallurgical ladles (members oₖ, k=1 . . . n), each of the several metallurgical ladles preferably comprises a member ID IDᵢ (preferably so that each member oᵢ bijectively corresponds to a specific member ID IDᵢ; oᵢ↔IDᵢ). A second class could be the class of slag pots, the class comprising slag pots, each of the several slag pots preferably comprise a member ID IDᵢ. A third class could be the class of tundishes, the class comprising tundishes, each of the several tundishes preferably comprise a member ID IDᵢ. A fourth class could be the class of scrap buckets/boxes, the class comprising scrap buckets/boxes, each of the several scrap buckets/boxes preferably comprise a (unique) member ID IDᵢ.

In the first providing step, the artificial intelligence-based detection algorithm is configured to detect a presence of any of the members oₖ, k=1 . . . n of the class of objects O={oₖ|k=1 . . . n} in an optical image. This may be achieved by prior training of the artificial intelligence-based detection algorithm, e.g., by supervised learning. This in turn might be achieved e.g., by providing many different optical images to the artificial intelligence-based detection algorithm, and manually telling the artificial intelligence-based detection algorithm if a certain optical image shows a presence of any of the members oₖ, k=1 . . . n of the class of objects O={oₖ|k=1 . . . n}. Thus, preferably the input of the artificial intelligence-based detection algorithm is an optical image, while the output of the artificial intelligence-based detection algorithm is the detected presence (e.g., by providing a Boolean variable such as true/false; or an array of Boolean variables or alternatively a probability or an array of probabilities) of any of the members oₖ, k=1 . . . n of the class of objects O={oₖ|k=1 . . . n} and for each detected presence a respective area with the presence of at least a part of any of the members oₖ, k=1 . . . n that is recognized. However, the output of the artificial intelligence-based detection algorithm does not comprise any information on the identification of the detected member. The area with the presence of at least a part of any of the members that is recognized can, e.g., be represented by coordinates of a bounding box (e.g., surrounding the detected member) or by a graphical representation of the area (such as in the sense of a cropped image).

In a capturing step at least a first optical image of a part of the metallurgical facility is provided, preferably in the form of a digital image. Preferably the imaging device is at a fixed (i.e., non-movable) location. In a detection step the artificial intelligence-based detection algorithm detects the presence of at least a part of any of the members oₖ, k=1 . . . n of the class of objects O={oₖ|k=1 . . . n} in the at least first optical image. In a detection step, the artificial intelligence-based detection algorithm provides an area (the area being a certain part of the at least first optical image) with the presence of at least a part of any of the members that is recognized.

Preferably, the steps after the detection step are only performed in case at least a part of any of the members oₖ, k=1 . . . n of the class of objects O={oₖ|k=1 . . . n} is detected in the area of the at least first optical image.

In a second providing step, the artificial intelligence-based identification algorithm is configured to identify the (specific) member oᵢ∈O out of the members oₖ, k=1 . . . n of the class of objects O={oₖ|k=1 . . . n} in the area. This may be achieved by prior training of the artificial intelligence-based identification algorithm, e.g., by supervised learning. The artificial intelligence-based identification algorithm is further configured to assign a member ID IDᵢ of the identified member oᵢ∈O of the class of objects O={oₖ|k=1 . . . n} to the object. The prior training might be achieved, e.g., by providing many different areas of an optical images with the presence of any of the members oₖ, k=1 . . . n of the class of objects O={oₖ|k=1 . . . n} (either as detected by the artificial intelligence-based detection algorithm, or by manually selecting such an area in different images), and manually telling the artificial intelligence-based identification algorithm that the respective area shows a (specific) member oᵢ∈O out of the members oₖ, k=1 . . . n of the class of objects O={oₖ|k=1 . . . n}, which is assigned (e.g., manually) to a certain member ID IDᵢ of the identified member. Thus preferably the input of the artificial intelligence-based identification algorithm is an area with the presence of at least a part of any of the members that is recognized, while preferably the output of the artificial intelligence-based identification algorithm is the member ID IDᵢ of the (specific) identified member oᵢ∈O of the class of objects O={oₖ|k=1 . . . n} in the area.

In the identification step the (specific) member oᵢ∈O of the class of objects O={oₖ|k=1 . . . n} in the area is identified and the member ID IDᵢ of the identified member oᵢ∈O of the class of objects O={oₖ|k=1 . . . n} is assigned to the object. Thereby the object is identified, as it is identified to be the (specific) member oᵢ∈O with the member ID IDᵢ.

An additional data providing step is performed where a data structure is provided to a central data processing unit, where the data structure comprises the member ID IDᵢ assigned to the object, preferably the data structure further comprises a time stamp. This allows a central data processing unit to log and track the position of a certain object, e.g., the course of a specific ladle may be tracked. A time stamp is generally a variable related to the actual time and date. Preferably the time stamp contains the time and date when the at least one optical image is provided by the capturing step. Receiving various data structures, each comprising a different member ID IDᵢ and a different time stamp, allows to gain an overview of the position and (possible) movements of objects, e.g., the positions and (possible) movements of ladles in a metallurgical facility.

Preferably, an additional calculation step is performed where a position of the object is calculated in a pre-defined coordinate system and whereas the data structure of the data providing step further comprises the position of the object in the pre-defined coordinate system. This allows to obtain a more precise position information of an object, e.g., the exact position of a ladle, instead of just a course position, like a ladle being in a certain section. A pre-defined coordinate system can be any coordinate system, such as, e.g., a coordinate system of the at least one optical imaging device, or a general coordinate system of a facility. By pre-defining a coordinate system, it is possible for a central data processing unit to interpret the position of an object correctly in the context of the chosen coordinate system. The position might be calculated from the position and the size of an object on the at least first optical image.

Preferably, in the capturing step a multitude of optical images of a part of the metallurgical facility is provided by a multitude of optical imaging device, such as 2D cameras. When positions of objects are obtained from optical images of different optical imaging devices, the data structure comprising the position of the objects in a pre-defined coordinate system allows to compare and track the position of different objects in different parts of a facility.

In case the data structure comprises the member ID IDᵢ assigned to the object, the time stamp, and the position of the object in the pre-defined coordinate system, this allows a very precise tracking of the object.

Preferably, each of the members oₖ, k=1 . . . n of the class of objects O={oₖ|k=1 . . . n} comprises a unique visual sign, preferably a unique visual sign comprising at least one of a digit (such as “1”, “2”, “3”, . . . ), a number (such as “100”, “200” “300”, . . . ), a letter (such as “A”, “B”, . . . ), a symbol (such as “°” or “°°” etc.) or a pattern. Preferably, the unique visual sign is integrally affixed to the respective member, e.g., in the sense of a protrusion or a recess build on the outer hull surface of the objects. Preferably, the unique visual sign is arranged such that the unique visual sign can be captured by the at least one optical imaging device, such as a 2D camera. Thus, the unique visual sign is preferably in a position such that it can be (easily) captured by a camera in a usual position of the object, and (depending on the geometry of the object) from outside the object. Also, the size of the unique visual sign is preferably such that the sign can be captured by the at least one optical imaging device, such as a 2D camera. Preferably, the artificial intelligence-based identification algorithm identifies the object based on the recognition of the unique visual sign affixed to the object. This has the effect that the artificial intelligence-based identification algorithm yields an increased number of successful identifications. Also, the training time of the artificial intelligence-based identification algorithm is reduced, especially in cases where several members of the class of objects have a generally similar appearance, in which case the affixed unique visual sign will be (mainly) used for distinguishing different members.

Preferably, the artificial intelligence-based detection algorithm is an artificial intelligence algorithm, preferably based on at least one of: a Decision Tree Regression (DT), a Random Forest Regression (RF), Support Vector Regression (SVR), a Neural Network (NN), which was previously trained by supervised learning.

Preferably, the artificial intelligence-based identification algorithm is an artificial intelligence algorithm, preferably based on at least one of: a Decision Tree Regression (DT), a Random Forest Regression (RF), Support Vector Regression (SVR), a Neural Network (NN), which was previously trained by supervised learning.

The artificial intelligence-based identification algorithm is different from the artificial intelligence-based detection algorithm. Even when the artificial intelligence-based identification algorithm and the artificial intelligence-based detection algorithm is based on the same type of algorithm, the training and the input/output of the artificial intelligence-based identification algorithm is different from the training and the input/output of the artificial intelligence-based detection algorithm.

Preferably, the class of objects O={oₖ|k=1 . . . n} consists of movable metallurgical vessels, such as at least one of: a ladle, a slag pot, a tundish, a scrap bucket/box. These objects have shown to provide good results for the artificial intelligence-based detection algorithm and the artificial intelligence-based identification algorithm in the harsh conditions of a metallurgical facility.

Preferably, the method further comprises a displaying step in which the data structure, such as a position of the object, is displayed to a user. Preferably, the displaying step is performed by a central data processing unit. Preferably, the data structure, such as a position of the object, is displayed to a user on a displaying device, such as a display or monitor. Preferably, the data structure is displayed in a graphical representation. Preferably, if the data structure comprises the member ID IDᵢ assigned to the object, the time stamp and the position of the object in the pre-defined coordinate system, the data structure is displayed in a graphical and dynamic representation, such as, e.g., showing the object in a graphical representation at the position of the object on a map.

The method further comprises a comparison step where a target provided from a production system, preferably the target comprises an object ID target and a position target, is compared with the data structure provided in the data providing step, preferably the data structure comprises the member ID IDᵢ assigned to the object and the position of the object. This allows to check that an object is at a certain position target, e.g., that a certain ladle is at a certain location, such as, e.g., a ladle heating station, at a given target time.

The method further comprises a warning step where a warning signal is generated in case the data structure differs from the target. Generally, the data structure may differ from a target, e.g., when a certain object, such as a specific ladle, is not at a target position at a certain time. Such a warning signal may alert a user in case that a certain object is not yet at a specified position, or also in a case where a certain object is still at a position while it should already have left that position (e.g., a ladle being already too long at the preheating position). This allows a user to set proper actions to better fulfil a certain production plan.

Preferably, the central data processing unit is programmed to store the data structure and to calculate a change in the data structure, such as a change in the position of the object in a pre-defined coordinate system, as a function of time. This allows to determine a change, such as e.g., a movement of the object as a function of time.

Preferably, the method further comprises a displaying step where the calculated change in the data structure, such as a change in the position of the object in a pre-defined coordinate system, as a function of time is displayed to a user. Preferably, the displaying step is performed by a central data processing unit. Preferably, the change in the data structure, such as a movement of the object, is displayed to a user on a displaying device, such as a display or monitor. Preferably, the change in data structure is displayed in a graphical representation. Preferably, if the data structure comprises the member ID IDᵢ assigned to the object, the time stamp and the position of the object in the pre-defined coordinate system, the change data structure is displayed in a graphical and dynamic representation, such as e.g., showing the movement of the object on a map.

Preferably, the at least one optical imaging device, such as a 2D camera, is set up such that the recognized area in the detection step takes up between 2% to 50% of a total area of the at least first optical image.

Preferably, the artificial intelligence-based detection algorithm is capable to detect the presence of at least a part of any of the members oₖ, k=1 . . . n of the class of objects O={oₖ|k=1 . . . n} taking up less than 5% of a total area of the at least first optical image.

In a second embodiment of the invention, the object is achieved by providing an acquisition system for identification of an object, such as a specific metallurgical ladle, out of members oₖ, k=1 . . . n of a class of objects O={oₖ|k=1 . . . n}, such as movable vessels, in a metallurgical facility, the system comprising:
An acquisition data processing unit programmed to perform a first providing step where an artificial intelligence-based detection algorithm is loaded, the artificial intelligence-based detection algorithm is configured to detect a presence of any of the members oₖ, k=1 . . . n of the class of objects O={oₖ|k=1 . . . n} in an optical image;
At least one optical imaging device, such as a 2D camera, for capturing at least a first optical image of a part of the metallurgical facility;
The acquisition data processing unit is programmed to perform a capturing step where at least a first optical image of a part of the metallurgical facility is provided by the at least one optical imaging device, such as the 2D camera;
The acquisition data processing unit is programmed to perform a detection step where the presence of any of the members oₖ, k=1 . . . n of the class of objects O={oₖ|k=1 . . . n} in the at least first optical image is detected by the artificial intelligence-based detection algorithm such that an area with the presence of at least a part of any of the members oₖ, k=1 . . . n of the class of objects O={oₖ|k=1 . . . n} in the at least first optical image is recognized;
The acquisition data processing unit is programmed to perform a second providing step where an artificial intelligence-based identification algorithm is loaded, the artificial intelligence based identification algorithm is configured to identify the member oᵢ∈O out of the members oₖ, k=1 . . . n of the class of objects O={oₖ|k=1 . . . n} in the area and further is configured to assign a member ID IDᵢ of the identified member oᵢ∈O of the class of objects O={oₖ|k=1 . . . n} to the object;
The acquisition data processing unit is programmed to perform an identification step where the member oᵢ∈O of the class of objects O={oₖ|k=1 . . . n} is identified in the area by the artificial intelligence-based identification algorithm by assigning the member ID IDᵢ of the identified member oᵢ∈O of the class of objects O={oₖ|k=1 . . . n} to the object.

The acquisition data processing unit of the acquisition system is further programmed to perform a data providing step where a data structure is provided to a central data processing unit, the data structure comprises the member ID IDᵢ assigned to the object, preferably the data structure further comprises a time stamp.

Preferably, the acquisition data processing unit of the acquisition system is further programmed to perform a calculation step where a position of the object is calculated in a pre-defined coordinate system, whereas the data structure of the data providing step further comprises the position of the object in the pre-defined coordinate system.

Preferably, the acquisition data processing unit of the acquisition system is further programmed such that the artificial intelligence-based identification algorithm, identifies the object based on the recognition of the unique visual sign integrally affixed to the object.

Preferably, the acquisition data processing unit of the acquisition system is further programmed such that:
the artificial intelligence-based detection algorithm is an artificial intelligence algorithm, preferably based on at least one of: a Decision Tree Regression (DT), a Random Forest Regression (RF), Support Vector Regression (SVR), a Neural Network (NN), which was previously trained by supervised learning; and
the artificial intelligence-based identification algorithm is an artificial intelligence algorithm, preferably based on at least one of: a Decision Tree Regression (DT), a Random Forest Regression (RF), Support Vector Regression (SVR), a Neural Network (NN), which was previously trained by supervised learning.

Preferably, the acquisition data processing unit of the acquisition system is further configured such that the class of objects O={oₖ|k=1 . . . n} consists of movable metallurgical vessels, such as at least one of a ladle, a slag pot, a tundish, a scrap bucket/box.

Preferably, the acquisition data processing unit of the acquisition system is further programmed to perform a displaying step in which the data structure, such as a position of the object, is displayed to a user.

Preferably, the at least one optical imaging device, such as a 2D camera, is set up such that the recognized area in the detection step takes up between 2% to 50% of a total area of the at least first optical image.

Preferably, the acquisition data processing unit of the acquisition system is further programmed such that the artificial intelligence-based detection algorithm is capable to detect the presence of at least a part of any of the members oₖ, k=1 . . . n of the class of objects O={oₖ|k=1 . . . n} taking up less than 5% of a total area of the at least first optical image.

Preferably, the imaging device is at a fixed (i.e., non-movable) location.

In a third embodiment of the invention, the object is achieved by providing a processing system for identification of an object, such as a specific metallurgical ladle, out of members oₖ, k=1 . . . n of a class of objects O={oₖ|k=1 . . . n}, such as movable vessels, in a metallurgical facility, the system comprising:
At least one acquisition system according to the second embodiment
A central data processing unit programmed to receive a data structure comprising a member ID IDᵢ and the position of the object from the at least one acquisition system.

Preferably, the central data processing unit is programmed to perform a displaying step in which the data structure, such as a position of the object, is displayed to a user in a graphical representation. Preferably the central data processing unit is connected to a displaying device, such as a display or monitor. Preferably the processing system further comprises a displaying device, such as a monitor, the displaying device being connected to the central data processing unit.

The central data processing unit is programmed to perform a comparison step where a target provided from a production system, preferably the target comprises an object ID target and a position target, is compared with the data structure provided in the data providing step, preferably the data structure comprises the member ID IDᵢ assigned to the object and the position of the object. The central data processing unit is programmed to perform a warning step where a warning signal is generated in case the data structure differs from the target.

Preferably, the central data processing unit is programmed to store the data structure and to calculate a change in the data structure, such as a change in the position of the object in a pre-defined coordinate system, as a function of time.

Preferably, the central data processing unit is programmed to perform a displaying step where the calculated change in the data structure, such as a change in the position of the object in a pre-defined coordinate system, as a function of time is displayed to a user.

Further characteristics of the invention result from the claims, the figures and the following figure description.

All features of the invention can be used individually or in combination. The advantages and refinements mentioned in connection with the method also apply analogously to the products/physical objects and vice versa.

Exemplary embodiments of the invention are explained in more detail by means of illustrations:

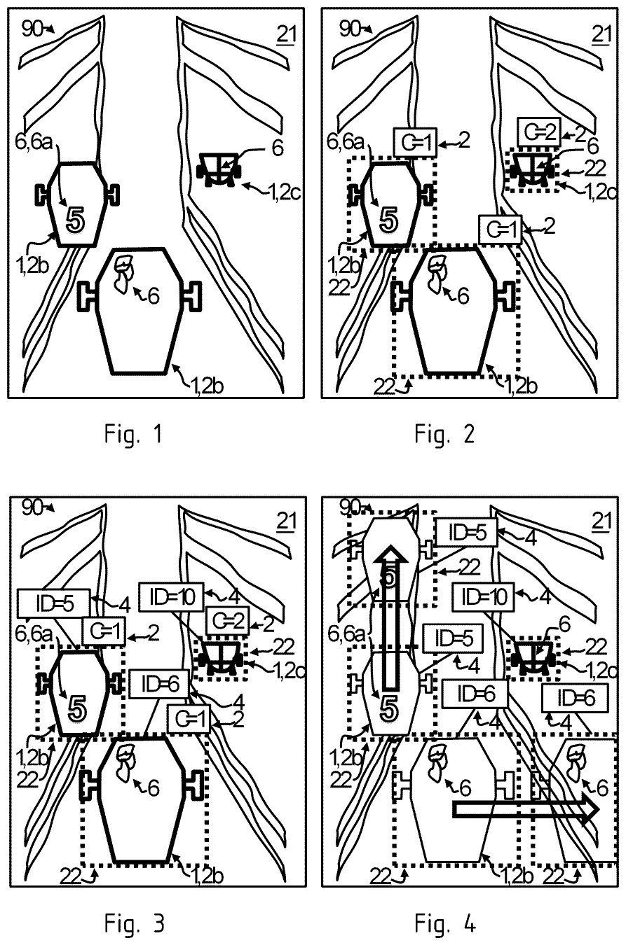

FIG. 1 to FIG. 4 show a schematic sequence of identification of objects in a metallurgical facility.

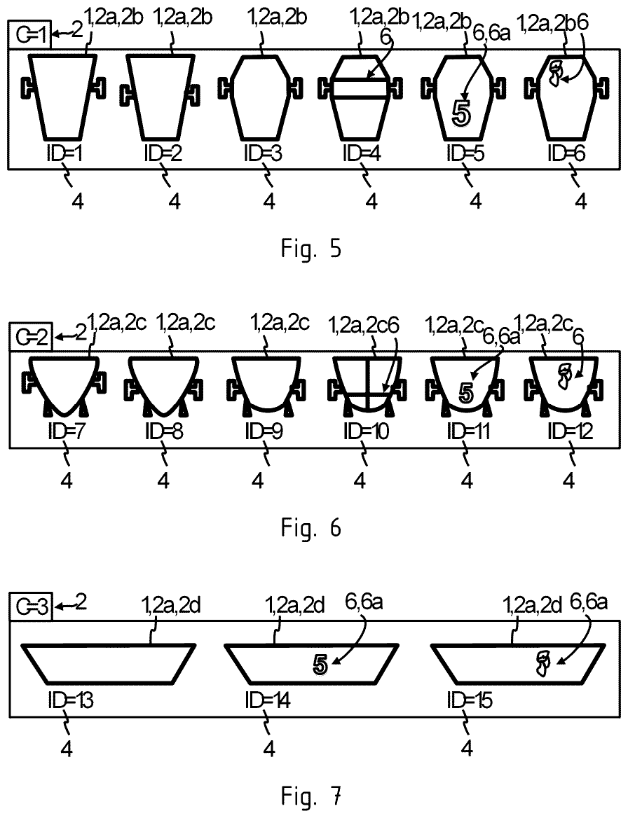

FIG. 5 schematically shows a class of objects of metallurgical ladles.

FIG. 6 schematically shows a class of objects of slag pots.

FIG. 7 schematically shows a class of objects of tundishes.

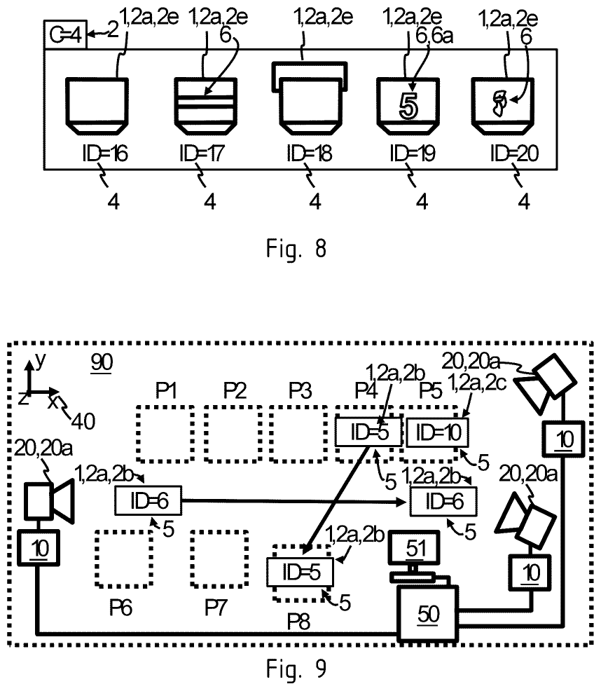

FIG. 8 schematically shows a class of objects of scrap buckets.

FIG. 9 shows the position and movements of objects in a metallurgical facility.

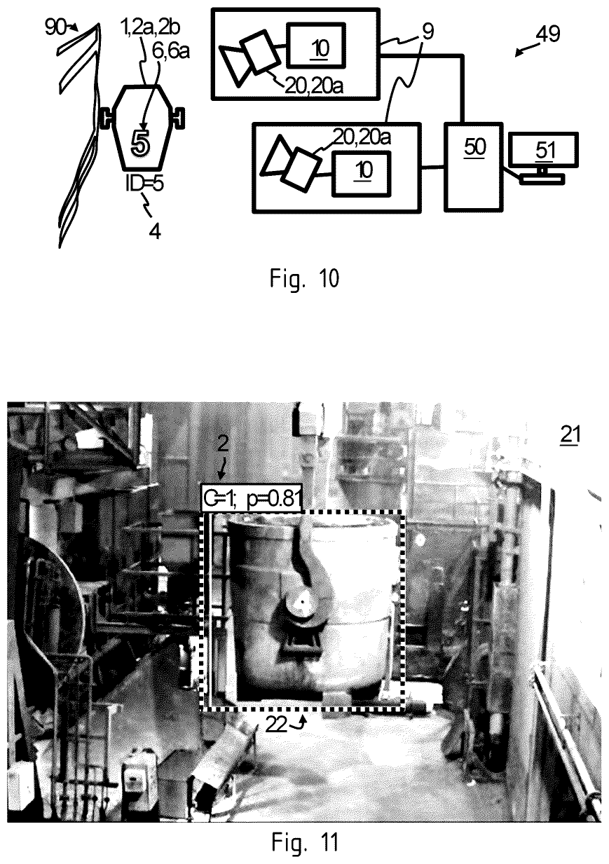

FIG. 10 shows a schematical configuration of an acquisition system and a processing system.

FIG. 11 shows a first optical image of a part of the metallurgical facility with an object.

In the following example, a first providing step (100) is performed where 6 specific metallurgical ladles (2b) shown in FIG. 5 as the members

$${o}_{k}^{( 1 )} , k = 1 … 6$$

(3) of the class of metallurgical ladles (2b) being the class of objects

$${O}^{( 1 )} = \{ {o}_{k}^{( 1 )} \vert k = 1 … 6 \}$$

(2) are provided and where an artificial intelligence-based detection algorithm (11) is provided, the artificial intelligence-based detection algorithm (11) is configured to detect a presence of any of the metallurgical ladles (2b)

$${o}_{k}^{( 1 )} , k = 1 … 6$$

(3) of the class metallurgical ladles (2b)

$${O}^{( 1 )} = \{ {o}_{k}^{( 1 )} \vert k = 1 … 6 \}$$

(2) in an optical image (21).

Additionally further members

$${o}_{k}^{( 2 )} , k = 1 … n$$

(3) of a class of objects

$${O}^{( 2 )} = \{ {o}_{k}^{( 2 )} \vert k = 1 … 6 \}$$

are provided in this example, such as the 6 specific slag pots (2c) shown in FIG. 6 (here the 6 slag pots (2c) are the members

$${o}_{k}^{( 2 )} , k = 1 … 6$$

(3) of a class of objects

$${O}^{( 2 )} = \{ {o}_{k}^{( 2 )} \vert k = 1 … 6 \} ,$$

the class of objects being the class of slag pots (2c)). Additionally, further members can be provided, such as the 3 specific tundishes (2d) of FIG. 7 (here the 3 tundishes (2d) are the members

$${o}_{k}^{( 3 )} , k = 1 … 3$$

(3) of a class of objects

$${O}^{( 3 )} = \{ {o}_{k}^{( 3 )} \vert k = 1 … 3 \} ,$$

the class of objects being the class of tundishes (2d)) or such as the 5 specific scrap buckets (2e) of FIG. 8 (here the 5 scrap buckets (2e) are the members

$${o}_{k}^{( 4 )} , k = 1 … 5$$

(3) of a class of objects

$${O}^{( 4 )} = \{ {o}_{k}^{( 4 )} \vert k = 1 … 5 \} ,$$

the class of objects being the class of scrap buckets (2e)). Each of the members are assigned with a member ID (4), e.g., with member ID from 1 to 6 for the metallurgical ladles (2b), member ID 7 to 12 for the slag pots (2c), member ID (4) 13 to 15 for the tundishes (2d) and member ID 16 to 20 for the scrap buckets (2e). Each class is assigned with a class identifier (e.g., C=1 for the class of metallurgical ladles (2b), C=2 for the class of slag pots (2c), C=3 for the class of tundishes (2d), C=4 for the class of scrap buckets (2e)). In the notation above, the class identifier is added as a superscript to members oₖ^{(c)} of a class of objects O^{(C)}.

A capturing step (200) is subsequently performed, where a first optical image (21) of a part of the metallurgical facility (90) is provided by at least one optical imaging device (20), which is a 2D camera (20a). The optical image (21) is exemplarily shown in FIG. 1, where a metallurgical facility (90) is shown, where several objects (1) can be seen, which will be subsequently identified. In this example of an optical image (21) the objects shown are a first metallurgical ladle (2b), with a visual sign (6) being the number ‘5’ (6a), another metallurgical ladle (2b) with a different visual sign (6) (here: a certain scratch pattern), and a slag pot (2c) with a visual sign (6) (here some structure of the slag pot).

After the capturing step (200) a detection step (300) is performed, where the presence of any of the members oₖ, k=1 . . . n (3)

$$( or {o}_{k}^{( 1 )} or {o}_{k}^{( 2 )} , … )$$

of the class of objects O={oₖ|k=1 . . . n} (2) (or O⁽¹⁾ or O⁽²⁾, . . . ) in the at least first optical image (21) is detected by the artificial intelligence-based detection algorithm (11), such that an area (22) with the presence of at least a part of any of the members oₖ, k=1 . . . n (3)

$$( or {o}_{k}^{( 1 )} , {o}_{k}^{( 2 )} , … )$$

of the class of objects O={oₖ|k=1 . . . n} (2) (or O⁽¹⁾ or O⁽²⁾, . . . ) in the at least first optical image (21) is recognized. Here a first metallurgical ladle (2b) (the one with a visual sign (6) being the number ‘5’ (6a)) is detected in a first area (22) as belonging to the class of metallurgical ladles (2b) (that is C=1), another metallurgical ladle (2b) with a different visual sign (6) (here: a certain scratch pattern) is also detected in a second area (22) as belonging to the class of metallurgical ladles (2b) (that is C=1), while the slag pot (2c) with a visual sign (6) (here some structure of the slag pot) is detected in a third area (22) as belonging to the class of slag pots (2c) (that is C=2). Each detected object is recognized in a certain area (22), which here is the area limited by a boundary box shown in FIG. 2.

In case the detection step (300) detects the presence of at least one object (1), the following steps below will be performed. In case no object (1) is detected, the capturing step (200) and the detection step (300) is repeated, until an object (1) is detected.

In case the detection step (300) detects the presence of at least one object (1), a second providing step (400) is performed where an artificial intelligence-based identification algorithm (12) is provided. The artificial intelligence-based identification algorithm (12) is configured to identify the member of oᵢ∈O (3) (or O⁽¹⁾ or O⁽²⁾, . . . ) out of the members oₖ, k=1 . . . n (3)

$$( or {o}_{k}^{( 1 )} , {o}_{k}^{( 2 )} , … )$$

of the class of objects O={oₖ|k=1 . . . n} (2) (or O⁽¹⁾ or O⁽²⁾, . . . ) in the area (22), and further is configured to assign a member ID IDᵢ (4) of the identified member oᵢ∈O (3) (or O⁽¹⁾ or O⁽²⁾, . . . ) of the class of objects O={oₖ|k=1 . . . n} (2) (or O⁽¹⁾ or O⁽²⁾, . . . ) to the object (1).

Subsequently, an identification step (500) is performed where the member oᵢ∈O (3) (or O⁽¹⁾ or O⁽²⁾, . . . ) of the class of objects O={oₖ|k=1 . . . n} (2) (or O⁽¹⁾ or O⁽²⁾, . . . ) is identified in the area (22) by the artificial intelligence-based identification algorithm (12) by assigning the member ID IDᵢ (4) of the identified member oᵢ∈O (3) or O⁽¹⁾ or O⁽²⁾, . . . ) of the class of objects O={oₖ|k=1 . . . n} (2) (or O⁽¹⁾ or O⁽²⁾, . . . ) to the object (1). This means that the artificial intelligence-based identification algorithm (12) identifies in the first area (22) the first metallurgical ladle (2b) out of the class of metallurgical ladles (2b) (that is C=1, shown in FIG. 5) to be the metallurgical ladle (2b) with the member ID 5 (ID=5). The artificial intelligence-based identification algorithm (12) also identifies in the second area (22) another metallurgical ladle (2b) with a different visual sign (6) (here: a certain scratch pattern) out of the class of metallurgical ladles (2b) (that is C=1, shown in FIG. 5) to be the metallurgical ladle (2b) with the member ID=6. The artificial intelligence-based identification algorithm (12) also identifies in the third area (22) the slag pot (2c) with a visual sign (6) (here some structure of the slag pot) out of the class of slag pots (2c) (that is C=2, shown in FIG. 6) to be the metallurgical ladle (2b) with the member ID=10. This is shown in FIG. 3.

In this example, an additional data providing step (700) is performed where a data structure (30) is provided to a central data processing unit (50), the data structure (30) comprises the member ID IDᵢ (4) assigned to the object (1), and a time stamp. An additional calculation step (600) is performed where a position (5) of the object (1) is calculated in a pre-defined coordinate system (40), which here is the cartesian (x,y,z) coordinate system of the metallurgical facility (90). The data structure (30) of the data providing step (700) further comprises the position (5) of the object (1) in this pre-defined coordinate system (40). The central data processing unit (50) is programmed to store the data structure (30) and to calculate a change in the data structure (30), such as a change in the position (5) of the object (1) in a pre-defined coordinate system (40). Receiving various data structures each comprising a different member ID (here ID=5, ID=6 and ID=10) (4) and a different time stamp allows to gain an overview of the position (5) and (possible) movements of objects, e.g., the positions (5) and (possible) movements of ladles (2b) in a metallurgical facility (90). Such movements are shown in FIG. 4, wherein the ladles with ID=5 and ID=6 are moved. By using this pre-defined coordinate system (40), it is possible for a central data processing unit (50) to interpret the position (5) of an object (1) correctly. Here, in the capturing step (200) a multitude of optical images (21) of a part of the metallurgical facility (90) are provided by a multitude of optical imaging device (20), here 2D cameras. When positions (5) of objects (1) are obtained from optical images (21) of different optical imaging devices, the data structure comprising the position (5) of the object (1) in a pre-defined coordinate system (40) allows to compare and track the position (5) of different objects (1) in different parts of a metallurgical facility (90).

In this example, the method further comprises a displaying step (800) in which the data structure (30), with the position (5) of the object (1), is displayed to a user (60). Here the displaying step is performed by a central data processing unit (50). The position (5) of the object (1), is displayed to a user on a displaying device (51), which here is a monitor. The data structure is displayed in a graphical dynamical representation as exemplarily shown in FIG. 9. This setup includes a multitude of optical imaging device (20), here 2D cameras. The position (5) of any object (1) is shown in a pre-defined coordinate system (40), which here is the cartesian (x,y,z) coordinate system (40) of the metallurgical facility (90). Here the objects (1) are graphically shown at the position (5) of the respective object (1) on a map, such as the slag pot (2c) with member ID=10 (4), its position (5) being at the position P5 (parking position). The map here is a sketch of the metallurgical facility (90) with certain sections (denoted P1 to P7), which are related to usual stations in a metallurgical facility (90), such as a preheating station, a drying station, a repair station, a preparation station, a station with the electric arc furnace (EAF) or alike. The map is generally adapted to a specific layout of a metallurgical facility (90). The map may also show the position of the imaging device (20), which are 2D cameras (20a) on a fixed location. Additionally, movements of objects (1) are shown on the map, which allows tracking identified objects (1), such as the ladles (2b) with member ID=5 (4) (moving from P4 to P8) and member ID=6 (4) (moving along a horizontal track, here from left to right).

In this example, the objects (1) have a unique visual sign (6) affixed to the object (1). Here the ladle (2b) with member ID=5 (4) has a unique visual sign comprising at least one of a digit (here: “5”). Here the ladle (2b) with member ID=5 (4) has a unique visual sign of a certain scratch pattern. And the slag pot (2c) with member ID=10 (4) has a unique visual sign of a structural element.

In this example, the method further comprises a comparison step (900) where a target (81) provided from a production system (80), preferably the target (81) comprises an object ID target (82) and a position target (83), is compared with the data structure (30) provided in the data providing step (700), preferably the data structure comprises the member ID IDᵢ (4) assigned to the object (1) and the position (5) of the object. Here the object ID target (82) and the position target (83) is that the ladle (2b) with member ID=5 (4) moves along the vertically shown track, which is fulfilled. Another object ID target (82) and the position target (83) is that the slag pot (2c) with member ID=10 (4) remains at its position (5) P5 (parking position) for a specified time interval. The method further comprises a warning step (1000) where a warning signal (85) is generated in case the data structure (30) differs from the target. Here this happens after the specified time interval for the slag pot (2c) with ID=10 (4) is over, while the slag pot (2c) with member ID=10 (4) is still residing at its position (5) P5 (the parking position). The warning signal (85) might be an optical signal on the map of FIG. 9 (e.g., that the object (1) is shown in a different color) or a sound signal or alike. The user can then interfere in the metallurgical process and trigger the slag pot (2c) with member ID=10 (4) to move away from its position (5) P5 (the parking position).

In this example, all optical imaging devices (20), such as a 2D camera (20a), are set up such that the recognized area (22) in the detection step (300) takes up between 2% to 50% of a total area of the at least first optical image (21). The artificial intelligence-based detection algorithm (11) is capable to detect the presence of at least a part of any of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ) taking up less than 5% of a total area of the at least first optical image.

The artificial intelligence-based detection algorithm (11) is an artificial intelligence algorithm based on a neural network (NN) which was previously trained by supervised learning. This artificial intelligence-based detection algorithm (11) is “only” trained to detect the presence a certain class/certain classes of objects. E.g., the artificial intelligence-based detection algorithm (11) might be trained to detect if any object (1) which belongs to the class of ladles (2b) or which belongs to the class of slag pots (2c) is present. Training is performed by supervised learning. In this case many optical images (21) from a metallurgical facility (90) are provided to the artificial intelligence-based detection algorithm (11). A human interaction specifies if an optical image (21) contains any object (1) from such a class, then artificial intelligence-based detection algorithm (11) is trained for such to recognize the presence of an object (1) from such a class, e.g., the artificial intelligence-based detection algorithm (11) is trained to recognize the presence of any object (1) belonging to the class of ladles (2b). The human interaction generally also includes manual “drawing” of a boundary box around the object (1), which is used such that the artificial intelligence-based detection algorithm (11) learns to recognize this boundary box as an area (22) with the presence of at least a part of any of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ).

The artificial intelligence-based identification algorithm (12) is an artificial intelligence algorithm based on a neural network (NN) which was previously trained by supervised learning. This artificial intelligence-based identification algorithm (12) is “only” trained to identify a (specific) member oᵢ∈O (3)

$$( or {o}_{k}^{( 1 )} or {o}_{k}^{( 2 )} … )$$

out of the members oₖ, k=1 . . . n (3) of the class of objects O={oₖ|k=1 . . . n} (or O⁽¹⁾ or O⁽²⁾, . . . ), in an area (22) where the presence of at least a part of any of the members oₖ, k=1 . . . n (3) of the class of objects O={oₖ|k=1 . . . n} (or O⁽¹⁾ or O⁽²⁾, . . . ) was previously recognized. In this example FIG. 2 shows two areas (22), where the presence of ladles (2b) was recognized (C=1), and one area (22) where the presence of a slag pot (2c) was recognized (C=2) by the artificial intelligence-based detection algorithm (11). The artificial intelligence-based identification algorithm (12) identifies in the first area (22) the first metallurgical ladle (2b) (the one with a visual sign (6) being the number ‘5’ (6a)) with the member ID=5 (4), in a second area (22) another metallurgical ladle (2b) with a different visual sign (6) (here: a certain scratch pattern) with the member ID=6 (4), and in the third area (22) the slag pot (2c) (that is C=2) with the member ID=10 (4). Training is performed by supervised learning. In this case many areas (22) with different members oₖ, k=1 . . . n (3)

$$( or {o}_{k}^{( 1 )} or {o}_{k}^{( 2 )} … )$$

of the class of objects O={oₖ|k=1 . . . n} (or O⁽¹⁾ or O⁽²⁾, . . . ) are used as the input for the artificial intelligence-based identification algorithm (12). A human interaction teaches the artificial intelligence-based identification algorithm (12) which specific member of oᵢ∈O (3) out of the members oₖ, k=1 . . . n (3)

$$( or {o}_{k}^{( 1 )} or {o}_{k}^{( 2 )} … )$$

of the class of objects O={oₖ|k=1 . . . n} (or O⁽¹⁾ or O⁽²⁾, . . . ) is present on each area (22), e.g. by specifying the respective member ID (4) of the specific member of oᵢ∈O (3) (or O⁽¹⁾ or O⁽²⁾, . . . ).

In this example the mentioned method steps are performed by an acquisition system (9) for identification of an object (1), such as a specific metallurgical ladle (2b), out of members oₖ, k=1 . . . n (3)

$$( or {o}_{k}^{( 1 )} or {o}_{k}^{( 2 )} … )$$

of a class or objects O={oₖ|k=1 . . . n} (2) (or O⁽¹⁾ or O⁽²⁾, . . . ), such as movable vessels (2a), in a metallurgical facility (90), such as shown in FIG. 10. The acquisition system (9) comprises an acquisition data processing unit (10) programmed to perform a first providing step (100) where an artificial intelligence-based detection algorithm (11) is loaded, the artificial intelligence-based detection algorithm (11) is configured to detect a presence of any of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ) in an optical image. It further comprises at least one optical imaging device (20), here a 2D camera (20a), for capturing at least a first optical image (21) of a part of the metallurgical facility (90). The acquisition data processing unit (10) is programmed to perform a capturing step (200) where at least a first optical image (21) of a part of the metallurgical facility (90) is provided by the at least one optical imaging device (20), that is the 2D camera (20a). The acquisition data processing unit (10) is programmed to perform a detection step (300) where the presence of any of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ) in the at least first optical image (21) is detected by the artificial intelligence-based detection algorithm (11) such that an area (22) with the presence of at least a part of any of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ) in the at least first optical image (21) is recognized. The acquisition data processing unit (10) is programmed to perform a second providing step (400) where an artificial intelligence-based identification algorithm (12) is loaded, the artificial intelligence based identification algorithm (12) is configured to identify the member of oᵢ∈O (3) (or O⁽¹⁾ or O⁽²⁾, . . . ) out of the members oₖ, k=1 . . . n (3)

$$( or {o}_{k}^{( 1 )} or {o}_{k}^{( 2 )} … )$$

of the class of objects O={oₖ|k=1 . . . n} (2) (or O⁽¹⁾ or O⁽²⁾, . . . ) in the area (22) and further is configured to assign a member ID IDᵢ (4) of the identified member oᵢ∈O (3) (or O⁽¹⁾ or O⁽²⁾, . . . ) of the class of objects O={oₖ|k=1 . . . n} (2) (or O⁽¹⁾ or O⁽²⁾, . . . ) to the object (1). The acquisition data processing unit (10) is programmed to perform an identification step (500) where the member oᵢ∈O (3) (or O⁽¹⁾ or O⁽²⁾, . . . ) of the class of objects O={oₖ|k=1 . . . n} (2) (or O⁽¹⁾ or O⁽²⁾, . . . ) is identified in the area (22) by the artificial intelligence-based identification algorithm (12) by assigning the member ID IDᵢ (4) of the identified member of oᵢ∈O (3) (or O⁽¹⁾ or O⁽²⁾, . . . ) of the class of objects O={oₖ|k=1 . . . n} (2) (or O⁽¹⁾ or O⁽²⁾, . . . ) to the object (1).

FIG. 10 also shows a processing system (49) for identification of an object (1), such as a specific metallurgical ladle (2b), out of members oₖ, k=1 . . . n (3)

$$( or {o}_{k}^{( 1 )} or {o}_{k}^{( 2 )} … )$$

of a class of objects O={oₖ|k=1 . . . n} (2) (or O⁽¹⁾ or O⁽²⁾, . . . ), such as movable vessels (2a), in a metallurgical facility (90), the system comprising at least one acquisition system (9) and a central data processing unit (50) programmed to receive a data structure (30) comprising a member ID IDᵢ (4) and the position (5) of the object (1) from the at least one acquisition system (9). The system further comprises a displaying device (51), such as a monitor, connected to the central data processing unit (50). While the acquisition system (9) may be positioned close to the objects (1), that is inside the metallurgical facility (90), the central data processing unit (50) can be positioned at a remote location, e.g., an office or alike.

FIG. 11 shows an actual optical image (21) of a part of the metallurgical facility (90) provided by at least one optical imaging device (20), which is a 2D camera (20a). A detection step (300) was performed, and the presence of any of the members oₖ, k=1 . . . n (3) of the class of objects O={oₖ|k=1 . . . n} (2) (here shown a ladle (2b) in the class of ladles (2), denoted by C=1 as in FIG. 5) was detected by the artificial intelligence-based detection algorithm (11) and an area (22) with the presence of the member (3) in the at least first optical image (21) is recognized. The output of the artificial intelligence-based detection algorithm (11) here is a probability value (p=0.81=81%), and the area (22). In a subsequent identification step (500) the member (3) will be identified in the area (22) and the respective member ID (4) will be assigned to the object (1).

### LIST OF REFERENCE NUMERALS AND FACTORS (GERMAN TRANSLATION IN PARENTHESIS)

1 Object
2 Class (or: set) of objects O={oₖ|k=1 . . . n} (with class identifier

$$C : {O}^{c} = \{ {o}_{k}^{c} \vert k = 1 … n \} )$$

2a Moveable vessels
2b Metallurgical ladle (metallurgische Pfanne)
2c Slag pot (Schlackenkübel)
2d Tundish (Verteiler)
2e Scrap bucket (Schrott-Schurre)
3 Member oₖ, k=1 . . . n (of class

$$C : {o}_{k}^{c} )$$

4 Member ID IDₖ, k=1 . . . n of members oₖ
5 Position of object
6 Visual sign
6a Digit (Ziffer)
6b Number (Zahl)
6c Letter (Buchstabe)
6d Symbol
9 Acquisition system
10 Acquisition data processing unit
11 Artificial intelligence-based detection algorithm
12 Artificial intelligence-based identification algorithm
20 Optical imaging device
20a 2D camera
21 Optical image
22 Area with the presence of at least a part of any of the members oₖ, k=1 . . . n (3)
30 Data structure
40 Pre-defined coordinate system
49 Processing system
50 Central data processing unit
51 Displaying device
60 User
80 Production system
81 Target
82 Object ID target
83 Position target
85 Warning signal
90 Metallurgical facility (metallurgisches Werk)
100 First providing step for providing members oₖ, k=1 . . . n (3) of a class of objects O={oₖ|k=1 . . . n} (2) and fort providing an artificial intelligence-based detection algorithm (11)
200 Capturing step for capturing at least a first optical image (21)
300 Detection step for detecting the presence of any of the members oₖ, k=1 . . . n (3) of the class of objects O={oₖ|k=1 . . . n} (2)
400 Second providing step for providing an artificial intelligence-based identification algorithm (12)
500 Identification step for identification of the object (1) out of the class of objects O={oₖ|k=1 . . . n} (2)
600 Calculation step for calculation of a position (5) of the object (1)
700 Data providing step for providing a data structure (30)
800 Displaying step to display the data structure (30) to a user (60)
900 Comparison step to compare a target (81) with the data structure (30)
1000 Warning step to generate a warning signal (85)

1. Method for identification of an object (1), such as a specific metallurgical ladle (2b), out of members oₖ, k=1 . . . n (3) of a class of objects O={oₖ|k=1 . . . n} (2), such as movable vessels (2a), in a metallurgical facility (90), the method comprising the following steps:
A first providing step (100) where members oₖ, k=1 . . . n (3) of a class of objects O={oₖ|k=1 . . . n} (2) are provided and where an artificial intelligence-based detection algorithm (11) is provided, the artificial intelligence-based detection algorithm (11) is configured to detect a presence of any of the members oₖ, k=1 . . . n (3) of the class of objects O={oₖ|k=1 . . . n} (2) in an optical image (21);
A capturing step (200) where at least one first optical image (21) of a part of the metallurgical facility (90) is provided by at least one optical imaging device (20), such as a 2D camera (20a);
A detection step (300) where the presence of any of the members oₖ, k=1 . . . n (3) of the class of objects O={oₖ|k=1 . . . n} (2) in the at least first optical image (21) is detected by the artificial intelligence-based detection algorithm (11), such that an area (22) with the presence of at least a part of any of the members oₖ, k=1 . . . n (3) of the class of objects O={oₖ|k=1 . . . n} (2) in the at least first optical image (21) is recognized;
A second providing step (400) where an artificial intelligence-based identification algorithm (12) is provided, the artificial intelligence based identification algorithm (12) is configured to identify the member of oᵢ∈O (3) out of the members oₖ, k=1 . . . n (3) of the class of objects O={oₖ|k=1 . . . n} (2) in the area (22) and further is configured to assign a member ID IDᵢ (4) of the identified member of oᵢ∈O (3) of the class of objects O={oₖ|k=1 . . . n} (2) to the object (1);
An identification step (500) where the member oᵢ∈O (3) of the class of objects O={oₖ|k=1 . . . n} (2) is identified in the area (22) by the artificial intelligence-based identification algorithm (12) by assigning the member ID IDᵢ (4) of the identified member oᵢ∈O (3) of the class of objects O={oₖ|k=1 . . . n} (2) to the object (1);
a data providing step (700) where a data structure (30) is provided to a central data processing unit (50), the data structure (30) comprises the member ID IDᵢ (4) assigned to the object (1), preferably the data structure (30) further comprises a time stamp;
a comparison step (900) where a target (81) provided from a production system (80), preferably the target (81) comprises an object ID target (82) and a position target (83), is compared with the data structure (30) provided in the data providing step (700), preferably the data structure comprises the member ID IDᵢ (4) assigned to the object (1) and the position (5) of the object (1);
a warning step (1000) where a warning signal (85) is generated in case the data structure (30) differs from the target (81).

2. Method according to claim 1 further comprising a calculation step (600) where the position (5) of the object (1) is calculated in a pre-defined coordinate system (40);
whereas the data structure (30) of the data providing step (700) further comprises the position (5) of the object (1) in the pre-defined coordinate system (40).

3. Method according to claim 1 whereas
each of the members oₖ, k=1 . . . n (3) of the class of objects O={oₖ|k=1 . . . n} (2) comprises a unique visual sign (6), preferably a unique visual sign comprising at least one of a digit (6a), a number (6b), a letter (6c), a symbol (6d);
the unique visual sign (6) is integrally affixed to the object (1);
the unique visual sign (6) is arranged such that the unique visual sign (6) can be captured by the at least one optical imaging device (20), such as a 2D camera (20);
the artificial intelligence-based identification algorithm (12), identifies the object (1) based on the recognition of the unique visual sign (6) affixed to the object (1).

4. Method according claim 1 whereas
the artificial intelligence-based detection algorithm (11) is an artificial intelligence algorithm, preferably based on at least one of: a Decision Tree Regression (DT), a Random Forest Regression (RF), Support Vector Regression (SVR), a Neural Network (NN), which was previously trained by supervised learning;
the artificial intelligence-based identification algorithm (12) is an artificial intelligence algorithm, preferably based on at least one of: a Decision Tree Regression (DT), a Random Forest Regression (RF), Support Vector Regression (SVR), a Neural Network (NN), which was previously trained by supervised learning.

5. Method according to claim 1 whereas the class of objects O={oₖ|k=1 . . . n} (2) consists of movable metallurgical vessels (2a), such as at least one of a ladle (2b), a slag pot (2c), a tundish (2d), a scrap bucket (2e).

6. Method according claim 1, the method further comprises:
a displaying step (800) in which the data structure (30), such as the position (5) of the object (1), is displayed to a user (60).

7. Method according to claim 2, whereas the central data processing unit (50) is programmed to store the data structure (30) and to calculate a change in the data structure (30), such as a change in the position (5) of the object (1) in a pre-defined coordinate system (40), as a function of time.

8. Method according claim 7, the method further comprises:
a displaying step (800) where the calculated change in the data structure (30), such as a change in the position (5) of the object (1) in a pre-defined coordinate system (40), as a function of time is displayed to a user (60).

9. Method according to claim 1 whereas the at least one optical imaging device (20), such as a 2D camera (20a), is set up such that the recognized area (22) in the detection step (300) takes up between 2% to 50% of a total area of the at least first optical image (21).

10. Method according to claim 1 whereas the artificial intelligence-based detection algorithm (11) is capable to detect the presence of at least a part of any of the members oₖ, k=1 . . . n (3) of the class of objects O={oₖ|k=1 . . . n} (2) taking up less than 5% of a total area of the at least first optical image (21).

11. Processing system (49) for identification of an object (1), such as a specific metallurgical ladle (2b), out of members oₖ, k=1 . . . n (3) of a class of objects O={oₖ|k=1 . . . n} (2), such as movable vessels (2a), in a metallurgical facility (90), the system comprising:
At least one acquisition system (9) comprising:
An acquisition data processing unit (10) programmed to perform a first providing step (100) where an artificial intelligence-based detection algorithm (11) is loaded, the artificial intelligence-based detection algorithm (11) is configured to detect a presence of any of the members oₖ, k=1 . . . n (3) of the class of objects O={oₖ|k=1 . . . n} (2) in an optical image (21);
At least one optical imaging device (20), such as a 2D camera (20a), for capturing at least a first optical image (21) of a part of the metallurgical facility (90);
The acquisition data processing unit (10) is programmed to perform a capturing step (200) where at least a first optical image (21) of a part of the metallurgical facility (90) is provided by the at least one optical imaging device (20), such as the 2D camera (20a);
The acquisition data processing unit (10) is programmed to perform a detection step (300) where the presence of any of the members oₖ, k=1 . . . n (3) of the class of objects O={oₖ|k=1 . . . n} (2) in the at least first optical image (21) is detected by the artificial intelligence-based detection algorithm (11) such that an area (22) with the presence of at least a part of any of the members oₖ, k=1 . . . n (3) of the class of objects O={oₖ|k=1 . . . n} (2) in the at least first optical image (21) is recognized;
The acquisition data processing unit (10) is programmed to perform a second providing step (400) where an artificial intelligence-based identification algorithm (12) is loaded, the artificial intelligence based identification algorithm (12) is configured to identify the member of oᵢ∈O (3) out of the members oₖ, k=1 . . . n (3) of the class of objects O={oₖ|k=1 . . . n} (2) in the area (22) and further is configured to assign a member ID IDᵢ (4) of the identified member oᵢ∈O (3) of the class of objects O={oₖ|k=1 . . . n} (2) to the object (1);
The acquisition data processing unit (10) is programmed to perform an identification step (500) where the member oᵢ∈O (3) of the class of objects O={oₖ|k=1 . . . n} (2) is identified in the area (22) by the artificial intelligence-based identification algorithm (12) by assigning the member ID IDᵢ (4) of the identified member oᵢ∈O (3) of the class of objects O={oₖ|k=1 . . . n} (2) to the object (1);
The acquisition data processing unit (10) is programmed to perform a data providing step (700) where a data structure (30) is provided to a central data processing unit (50), the data structure (30) comprises the member ID IDᵢ (4) assigned to the object (1), preferably the data structure (30) further comprises a time stamp;
A central data processing unit (50) programmed to receive a data structure (30) comprising a member ID IDᵢ (4) and a position (5) of the object (1) from the at least one acquisition system (9) and programmed to perform the steps:
a comparison step (900) where a target (81) provided from a production system (80), preferably the target (81) comprises an object ID target (82) and a position target (83), is compared with the data structure (30) provided in the data providing step (700), preferably the data structure comprises the member ID IDᵢ (4) assigned to the object (1) and the position (5) of the object (1);
a warning step (1000) where a warning signal (85) is generated in case the data structure (30) differs from the target (81).

12. Processing system (49) according to claim 11, whereas the acquisition system (9) is further programmed to perform a calculation step (600) where the position (5) of the object (1) is calculated in a predefined coordinate system (40);
whereas the data structure (30) of the data providing step (700) further comprises the position (5) of the object (1) in the pre-defined coordinate system (40).

13. Processing system (49) according claim 11 whereas:
The central data processing unit (50) programmed to receive a data structure (30) comprising a member ID IDᵢ (4) and the position (5) of the object (1) from the at least one acquisition system (9) and programmed to perform a displaying step (800) in which the data structure (30), such as a position (5) of the object (1), is displayed to a user (60).

14. Processing system (49) according to claim 11 whereas
each of the members oₖ, k=1 . . . n (3) of the class of objects O={oₖ|k=1 . . . n} (2) comprises a unique visual sign (6), preferably a unique visual sign comprising at least one of a digit (6a), a number (6b), a letter (6c), a symbol (6d);
the unique visual sign (6) is integrally affixed to the object (1);
the unique visual sign (6) is arranged such that the unique visual sign (6) can be captured by the at least one optical imaging device (20), such as a 2D camera (20);
the artificial intelligence-based identification algorithm (12), identifies the object (1) based on the recognition of the unique visual sign (6) affixed to the object (1).

15. Processing system (49) according to claim 11 whereas
the artificial intelligence-based detection algorithm (11) is an artificial intelligence algorithm, preferably based on at least one of: a Decision Tree Regression (DT), a Random Forest Regression (RF), Support Vector Regression (SVR), a Neural Network (NN), which was previously trained by supervised learning;
the artificial intelligence-based identification algorithm (12) is an artificial intelligence algorithm, preferably based on at least one of: a Decision Tree Regression (DT), a Random Forest Regression (RF), Support Vector Regression (SVR), a Neural Network (NN), which was previously trained by supervised learning.

16. Processing system (49) according to claim 11 whereas the class of objects O={oₖ|k=1 . . . n} (2) consists of movable metallurgical vessels (2a), such as at least one of a ladle (2b), a slag pot (2c), a tundish (2d), a scrap bucket (2e).

17. Processing system (49) according to claim 11 whereas the at least one optical imaging device (20), such as a 2D camera (20a), is set up such that the recognized area (22) in the detection step (300) takes up between 2% to 50% of a total area of the at least first optical image (21).

18. Processing system (49) according to claim 11 whereas the artificial intelligence-based detection algorithm (11) is capable to detect the presence of at least a part of any of the members oₖ, k=1 . . . n (3) of the class of objects O={oₖ|k=1 . . . n} (2) taking up less than 5% of a total area of the at least first optical image (21).
